(19) United States
(12) Patent Application Publication
(10) Pub. No.: US 2011/0042597 A1
(43) Pub. Date: Feb. 24, 2011

(54) MAGNETICALLY DRIVEN HIGH SPEED PNEUMATIC VALVE

(76) Inventors: John Christopher Huculak, Mission Viejo, CA (US); Brian William McDonnell, Irvine, CA (US)

Correspondence Address: ALCON, IP LEGAL, TB4-8, 6201 SOUTH FREEWAY, FORT WORTH, TX, 76134, US

(21) Appl. No.: 12/858,864

(22) Filed: Aug. 18, 2010

Related U.S. Application Data
(60) Provisional application No. 61/235,162, filed on Aug. 19, 2009.

(51) Int. Cl. F16K 31/02

(52) U.S. Cl. 251/129.15

(57) ABSTRACT

A high speed pneumatic valve has a housing enclosing a cavity with an inlet port and an outlet port. A permanently magnetized armature is located in the cavity. The permanently magnetized armature moves between a first, open position and a second, closed position. A coil and magnetic core assembly is located near the armature in the housing. A first voltage applied across the coil results in a magnetic field with a first polarity being induced in the magnetic core thereby attracting the armature toward the magnetic core and away from the outlet port. A second voltage applied across the coil results in a magnetic field with a second, opposite polarity being induced in the magnetic core thereby repelling the armature away from the magnetic core and toward the outlet port.

### RELATED APPLICATIONS

This application claims priority to U.S. provisional application Ser. No. 61/235,162, filed on Aug. 19, 2009 the contents which are incorporated herein by reference.

### BACKGROUND OF THE INVENTION

The present invention relates to a high speed valve with a magnetized armature for use with a high speed vitrectomy probe.

Vitreo-retinal procedures include a variety of surgical procedures performed to restore, preserve, and enhance vision. Vitreo-retinal procedures are appropriate to treat many serious conditions of the back of the eye. Vitreo-retinal procedures treat conditions such as age-related macular degeneration (AMD), diabetic retinopathy and diabetic vitreous hemorrhage, macular hole, retinal detachment, epiretinal membrane, CMV retinitis, and many other ophthalmic conditions.

The vitreous is a normally clear, gel-like substance that fills the center of the eye. It makes up approximately two-thirds of the eye's volume, giving it form and shape before birth. Certain problems affecting the back of the eye may require a vitrectomy, or surgical removal of the vitreous.

A vitrectomy may be performed to clear blood and debris from the eye, to remove scar tissue, or to alleviate traction on the retina. Blood, inflammatory cells, debris, and scar tissue obscure light as it passes through the eye to the retina, resulting in blurred vision. The vitreous is also removed if it is pulling or tugging the retina from its normal position. Some of the most common eye conditions that require a vitrectomy include complications from diabetic retinopathy such as retinal detachment or bleeding, macular hole, retinal detachment, pre-retinal membrane fibrosis, bleeding inside the eye (vitreous hemorrhage), injury or infection, and certain problems related to previous eye surgery.

A retinal surgeon performs a vitrectomy with a microscope and special lenses designed to provide a clear image of the back of the eye. Several tiny incisions just a few millimeters in length are made on the sclera. The retinal surgeon inserts microsurgical instruments through the incisions such as a fiber optic light source to illuminate inside the eye, an infusion line to maintain the eye's shape during surgery, and instruments to cut and remove the vitreous.

In a vitrectomy, the surgeon creates three tiny incisions in the eye for three separate instruments. These incisions are placed in the pars plana of the eye, which is located just behind the iris but in front of the retina. The instruments which pass through these incisions include a light pipe, an infusion port, and the vitrectomy cutting device or vitrectomy probe. The light pipe is the equivalent of a microscopic high-intensity flashlight for use within the eye. The infusion port is required to replace fluid in the eye and maintain proper pressure within the eye. The vitrectomy probe, or cutting device, works like a tiny guillotine, with an oscillating microscopic cutter to remove the vitreous gel in a controlled fashion. This prevents significant traction on the retina during the removal of the vitreous.

The vitrectomy probe is actuated pneumatically. In order to achieve very high cut rates, a high speed valve is used. High speed pulse or jet valves are designed to deliver very fast air pulses. They are often used for high speed part sorting. Some jet valves utilize a flat plate armature to control the air flow. When de-energized, this plate is held against the sealing surface by the air pressure, thereby stopping the flow. When energized, this plate is quickly pulled off the sealing surface, in less than a millisecond, allowing air to flow. When again de-energized, the plate is simply released relying on the air pressure to press the armature against the sealing surface and stopping the flow. The problem that occurs is that the motion of the armature during the closing action is unpredictable. With only the force of the air differential providing the closing force, the armature plate will bounce around before settling on the sealing surface and stopping the flow. This variation in closing time, while acceptable for a part sorting application, is not suitable for an application requiring consistent closing times such as eye surgery. The present invention is for an improved high speed valve.

### SUMMARY OF THE INVENTION

In one embodiment consistent with the principles of the present invention, the present invention is a high speed pneumatic valve. The valve has a housing enclosing a cavity with an inlet port and an outlet port. A permanently magnetized armature is located in the cavity. The permanently magnetized armature moves between a first, open position and a second, closed position. A coil and magnetic core assembly is located near the armature in the housing. A first voltage applied across the coil results in a magnetic field with a first polarity being induced in the magnetic core thereby attracting the armature toward the magnetic core and away from the outlet port. A second voltage applied across the coil results in a magnetic field with a second, opposite polarity being induced in the magnetic core thereby repelling the armature away from the magnetic core and toward the outlet port.

In one embodiment consistent with the principles of the present invention, the present invention is a high speed pneumatic valve. The valve has a housing enclosing a cavity with an inlet port and an outlet port. A ferromagnetic armature is located in the cavity. The armature moves between a first, open position and a second, closed position. A first coil and magnetic core assembly is located near the armature in the housing. A second coil and magnetic core assembly is located near the armature in the housing and opposite the first core and coil assembly. A first voltage applied across the first coil results in a magnetic field being induced in the first magnetic core thereby attracting the armature toward the first magnetic core and away from the outlet port, and a second voltage applied across the second coil results in a magnetic field with a polarity being induced in the second magnetic core thereby attracting the armature toward the second magnetic core and toward the outlet port

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1A is a cross section view of a high speed valve in an open position according to the principles of the present invention.

FIG. 1B is a cross section view of a high speed valve in a closed position according to the principles of the present invention.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

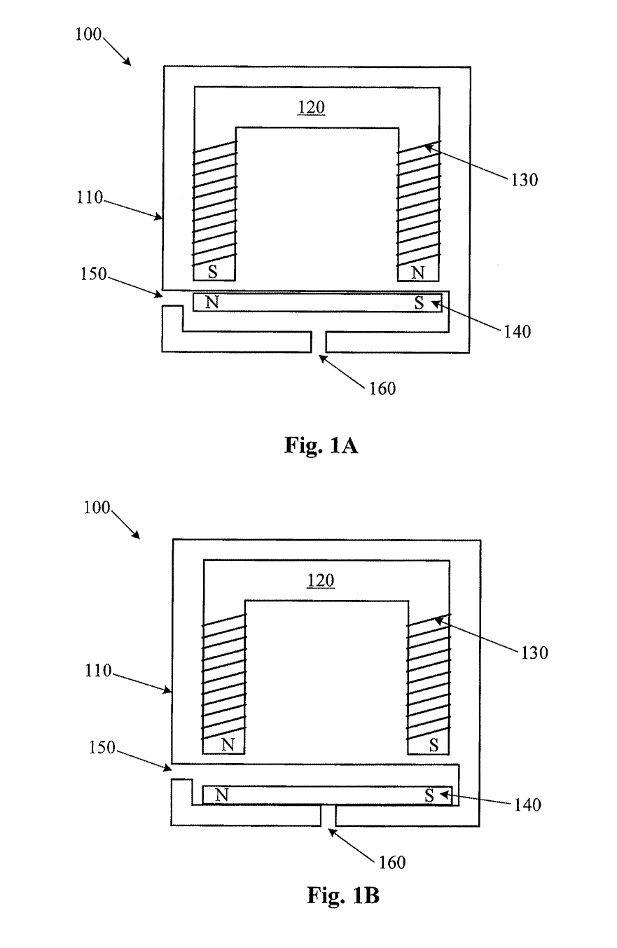

FIG. 1A is a cross section view of a high speed valve in an open position according to the principles of the present invention. FIG. 1B is a cross section view of a high speed valve in a closed position according to the principles of the present invention. In FIGS. 1A and 1B, high speed valve 100 includes housing 110, magnetic core 120, coil 130, armature 140, inlet port 150, and outlet port 160. Armature 140 moves up and down as shown to open or close outlet port 160. When in the open position of FIG. 1A, air flows through inlet port 150 and out of outlet port 160. When in the closed position of FIG. 1B, air cannot exit outlet port 160.

A first voltage across coil 130 produces the polarity shown in magnetic core 120 in FIG. 1A. A second, opposite voltage across coil 130 produces the polarity shown in magnetic core 120 in FIG. 1B. As is commonly known, a voltage across coil 130 (or a current through coil 130) produces a magnetic filed in magnetic core 120. Applying a positive voltage across coil 130 produces a first magnetic polarity, and applying a negative voltage across coil 130 produces a second, opposite polarity. For example, a positive voltage across coil 130 produces the polarity shown in FIG. 1A, and a negative voltage across coil 130 produces the polarity shown in FIG. 1B.

In a traditional high speed valve, armature 140 is made of a ferromagnetic material. In such a case, when coil 130 is energized and a magnetic field is induced in magnetic core 120, armature 140 is attracted to magnetic core 120. When coil 130 is de-energized, armature 140 is no longer attracted to magnetic core 120 and is allowed to close outlet port 160 with the aid of air pressure. As discussed in the background section, this causes armature to rattle resulting in imprecise closing times.

In the present invention, armature 140 is permanently magnetized. In this case, when a first voltage is applied across coil 130 as shown in FIG. 1A, armature 140 is attracted to magnetic core 120 (the armature moves upward) and the valve 100 is in the open position. When an opposite voltage is applied across coil 130, armature 140 is repelled by the magnetic force induced in magnetic core 120 as shown in FIG. 1B. As such, this magnetic repulsion forces armature 140 downward thereby occluding outlet port 160 and turning valve 100 off.

Magnetizing armature 140 has several advantages. First, opening and closing times can be more rapid. Since armature 140 is either attracted to or repelled by the magnetic field induced in magnetic core 120, a magnetic force propels armature 140 at a very high speed. Second, the valve can be closed in a very fast and reliable manner. Using a repulsive magnetic force assures that armature 140 travels downward to occlude outlet port 160 in a very quick manner.

In another embodiment of the present invention, a second coil and magnetic core (not shown) can be located opposite coil 130 and magnetic core 120. In this manner, armature 140 need not be permanently magnetized. Instead, a voltage can be alternated between coil 130 and the second coil (not shown). In this manner, two different core and coil assemblies can be used to produce alternating magnetic forces to propel armature 140 between an open and closed position. For example, a voltage applied across coil 130 results in a magnetic field in core 120 that pulls armature 140 toward it. At the same time, there is no voltage across the second coil. This results in opening the valve. Immediately thereafter, the voltage is removed from coil 130, and a voltage is applied across the second coil (not shown) resulting in a magnetic field being generated in the second core (not shown). This results in the armature 140 being pulled in the direction of the second core (not shown) so that the valve is in the closed position. In such an arrangement, the armature is not magnetized—it is simply made of a ferromagnetic material.

Other configurations of valve 100 are also contemplated. For example, valve 100 may have one inlet port and two outlet ports. The second outlet port (not shown) can be located opposite the first outlet port 160. In this manner, valve 100 can operate in a 3/2-way manner. This operation is possible only with a magnetized armature 140 or with two core and coil assemblies (and a ferromagnetic armature) because the armature can be held in an open or closed position with the use of a magnetic force.

The same concept can be used to improve the closing performance of other valves as well. The addition of a magnetic force that pulls a valve closed as well as holds the valve open can be used to improve valve performance. For example, in a spider valve, a leaf spring holds the armature of the valve in a closed position (normally closed spider valve). When a solenoid is energized, the armature is forced open. When the solenoid is de-energized, the leaf spring brings the armature to the closed position. The design of the spider valve requires a leaf spring with a spring constant that produces a spring force that can be overcome by the force applied by the solenoid. In other words, the spring applies a force on the armature in one direction (closed direction, in this case), and the solenoid applies a force on the armature in the opposite direction (to open the valve). An additional magnetic force (either with a second core and coil or a magnetized armature) can be used to supplement the spring force to more rapidly and reliably close the valve.

The valve 100 of the present invention can be used to drive a vitrectomy probe (not shown). A vitrectomy probe operates pneumatically so that the higher the valve opening and closing times, the faster the probe can operate. A typical vitrectomy probe has a first tube disposed coaxially within a second tube. The first tube is moved up and down inside the second tube at a very high rate of speed (the cut rate). The distal end of the first tube has a cutting blade that cuts vitreous. The high speed valve of the present invention allows for the inner tube to be reciprocated at a very high rate resulting in a very high cut rate.

From the above, it may be appreciated that the present invention provides an improved high speed air valve. The armature of the air valve is permanently magnetized so that the valve can be closed quickly and reliably. The present invention is illustrated herein by example, and various modifications may be made by a person of ordinary skill in the art.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A high speed pneumatic valve comprising:
a housing having a cavity with an inlet port and an outlet port;
a permanently magnetized armature located in the cavity, the permanently magnetized armature moving between a first, open position and a second, closed position; and
a coil and magnetic core assembly located near the armature in the housing;
wherein a first voltage applied across the coil results in a magnetic field with a first polarity being induced in the magnetic core thereby attracting the armature toward the magnetic core and away from the outlet port, and a second voltage applied across the coil results in a magnetic field with a second, opposite polarity being induced in the magnetic core thereby repelling the armature away from the magnetic core and toward the outlet port.

2. A high speed pneumatic valve comprising:
a housing having a cavity with an inlet port and an outlet port;
a ferromagnetic armature located in the cavity, the armature moving between a first, open position and a second, closed position; and
a first coil and magnetic core assembly located near the armature in the housing;
a second coil and magnetic core assembly located near the armature in the housing and opposite the first core and coil assembly;
wherein a first voltage applied across the first coil results in a magnetic field being induced in the first magnetic core thereby attracting the armature toward the first magnetic core and away from the outlet port, and a second voltage applied across the second coil results in a magnetic field with a polarity being induced in the second magnetic core thereby attracting the armature toward the second magnetic core and toward the outlet port.
